(19) United States
(12) Patent Application Publication
(10) Pub. No.: US 2026/0296400 A1
(43) Pub. Date: Oct. 1, 2026

(54) CONTROL APPARATUS FOR TWO-WHEEL DRIVE VEHICLE

(71) Applicant: TOYOTA JIDOSHA KABUSHIKI KAISHA, Toyota-shi (JP)

(72) Inventors: Yusuke MIIDA, Toyota-shi (JP); Takafumi RIKIISHI, Toyota-shi (JP)

(73) Assignee: TOYOTA JIDOSHA KABUSHIKI KAISHA, Toyota-shi (JP)

(21) Appl. No.: 19/577,787

(22) Filed: Mar. 25, 2026

(30) Foreign Application Priority Data
Mar. 25, 2025 (JP) 2025-050748

(51) Int. Cl. B60W 20/50; B60W 10/02; B60W 10/06; B60W 10/08; B60W 10/115; B60W 50/029

(52) U.S. Cl. CPC B60W 20/50; B60W 10/02; B60W 10/06; B60W 10/08; B60W 10/115; B60W 50/029; B60W 2050/0292; B60W 2510/10; B60W 2520/10; B60W 2710/021; B60W 2710/0644; B60W 2710/1005

(57) ABSTRACT

A control apparatus for a two-wheel drive vehicle in which that a first clutch, an electric motor, a second clutch and an automatic transmission are arranged in this order as viewed in a direction away from an engine toward drive wheels. When a vehicle running speed is not higher than a predetermined speed value in event of a gear-position limited state in which the transmission cannot be placed in gear positions except in at least one available gear position, such that a gear ratio of a lowest-speed gear position of the at least one available gear position is not higher than a predetermined ratio value, an electric-motor evacuation driving control is executed for driving the vehicle with a power of the electric motor, by placing the transmission in the lowest-speed gear position, placing the first clutch in a released state and placing the second clutch in an engaged state.

This application claims priority from Japanese Patent Application No. 2025-050748 filed on Mar. 25, 2025, the disclosure of which is herein incorporated by reference in its entirety.

### FIELD OF THE INVENTION

The present invention relates to a control apparatus for a two-wheel drive vehicle that includes an engine, drive wheels, a first clutch, an electric motor, a second clutch and an automatic transmission that is to be placed in a plurality of gear positions, such that the first clutch, the electric motor, the second clutch and the automatic transmission are disposed in a power transmission path between the engine and the drive wheels and are arranged in this order as viewed in a direction away from the engine toward the drive wheels.

### BACKGROUND OF THE INVENTION

There is known a control apparatus for a two-wheel drive vehicle that includes an engine, drive wheels, a first clutch, an electric motor, a second clutch and an automatic transmission that is to be placed in a plurality of gear positions, such that the first clutch, the electric motor, the second clutch and the automatic transmission are disposed in a power transmission path between the engine and the drive wheels and are arranged in this order as viewed in a direction away from the engine toward the drive wheels. For example, such a control apparatus is described in Patent Document 1. Patent Document 1 discloses a technique related to an evacuation driving in event of an abnormality of a power transmission to front wheels in a four-wheel drive (4WD) vehicle in which auxiliary drive wheels (rear wheels) are driven by a power of a second electric motor in addition to drive wheels (front wheels). For example, Patent Document 1 discloses that, in event of a gear-position limited state in which the automatic transmission cannot be placed in the gear positions except in at least one available gear position, due to an abnormality of the automatic transmission, when a running speed of the vehicle is not lower than a predetermined speed value, a first evacuation driving is performed whereby the front wheels are driven with the automatic transmission being placed in one of the at least one available gear position, and when the running speed is lower than the predetermined speed value, the power transmission to the front wheels is cut off and a second evacuation driving is performed whereby the rear wheels are driven by the power of the second electric motor.

### Prior Art Document

### Patent Document

[Patent Document 1] JP 2022-63156 A

### SUMMARY OF THE INVENTION

The above-described second evacuation driving can be performed in a four-wheel drive (4WD) vehicle with independent power transmission paths to the front wheels and to the rear wheels, but cannot be performed in a two-wheel drive (2WD) vehicle with a single power transmission path. Further, in a two-wheel drive (2WD) vehicle, in event of a gear-position limited state in which the automatic transmission cannot be placed in the gear positions except in a high-speed gear position having a low gear ratio, and if the first evacuation driving is performed in this case, an excessively large load is applied to the second clutch when the vehicle starts running or runs at a low speed, which could result in component damage due to overheating, or could result in poor running start or insufficient driving force due to load factor restrictions. This is because when the vehicle starts running or runs at a low speed with the automatic transmission being placed in the high-speed gear position, heat generation in the second clutch is increased due to increase of transmission torque and expansion of slip state region.

The present invention was made against the background of the above circumstances, and its purpose is to provide a control apparatus for a two-wheel drive (2WD) vehicle, which is capable of performing an evacuation driving while preventing component damage and poor running start due to overheating of the second clutch, even in event of a gear-position limited state in which the automatic transmission can be placed in only a high-speed gear position due to an abnormality of the automatic transmission.

According to the present invention, there is provided a control apparatus for a two-wheel drive vehicle that includes an engine, drive wheels, a first clutch, an electric motor, a second clutch and an automatic transmission that is to be placed in a plurality of gear positions, such that the first clutch, the electric motor, the second clutch and the automatic transmission are disposed in a power transmission path between the engine and the drive wheels and are arranged in this order as viewed in a direction away from the engine toward the drive wheels. When a running speed of the vehicle is not higher than a predetermined speed value in event of a gear-position limited state in which the automatic transmission cannot be placed in the gear positions except in at least one available gear position, such that a gear ratio of a lowest-speed gear position of the at least one available gear position, which is higher than a gear ratio of any other gear position of the at least one available gear position, is not higher than a predetermined ratio value, the control apparatus is configured to execute an electric-motor evacuation driving control for driving the vehicle with a power of the electric motor, by placing the automatic transmission in the lowest-speed gear position, placing the first clutch in a released state and placing the second clutch in an engaged state.

In the control apparatus according to the present invention, when the running speed of the vehicle is not higher than the predetermined speed value in event of the gear-position limited state in which the automatic transmission cannot be placed in the gear positions except in at least one available gear position, such that the gear ratio of the lowest-speed gear position of the at least one available gear position, which is higher than the gear ratio of any other gear position of the at least one available gear position, is not higher than the predetermined ratio value, the control apparatus is configured to execute the electric-motor evacuation driving control for driving the vehicle with the power of the electric motor, by placing the automatic transmission in the lowest-speed gear position, placing the first clutch in the released state and placing the second clutch in the engaged state. As a result, in the two-wheel drive (2WD) vehicle, even when the at least one available gear position is limited to a high-speed gear position with a low gear ratio, due to an abnormality in the automatic transmission, the evacuation driving is performed while preventing component damage and poor running starts due to overheating of the second clutch.

### BRIEF DESCRIPTION OF THE DRAWINGS

FIG. 1 is a view schematically showing a construction of a two-wheel drive vehicle to which the present invention is applied.

FIG. 2 is a flowchart showing main parts of control operations of an electronic control apparatus, namely, a control routine executed for performing an evacuation driving when an automatic transmission is in a gear-position limited state.

FIG. 3 is a view schematically showing a construction of a four-wheel drive vehicle of a comparative example, for explaining an evacuation driving performed in this vehicle of the comparative example when an automatic transmission is in a gear-position limited state.

### DETAILED DESCRIPTION OF PREFERRED EMBODIMENT

Hereinafter, a preferred embodiment of the present invention will be described in detail with reference to the drawings. It is noted that the drawings have been appropriately simplified or modified, and dimensional ratios and shapes of various parts are not necessarily drawn accurately.

### Embodiment

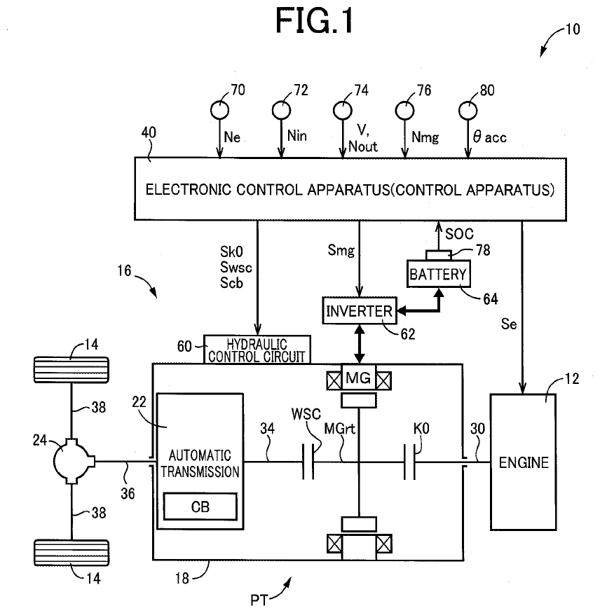

FIG. 1 is a view schematically showing a construction of a two-wheel drive vehicle (hereinafter simply referred to as “vehicle”) 10 to which the present invention is applied.

The vehicle 10 is a two-wheel drive (2WD) hybrid electric vehicle including an engine 12 and an electric motor MG as power sources. The vehicle 10 further includes a power transmission device 16 provided in a power transmission path PT between the engine 12 and a pair of drive wheels 14. The power transmission device 16 includes a casing 18, a connection/disconnection clutch K0, the electric motor MG, a starting clutch WSC, an input shaft 34, an automatic transmission 22, an output shaft 36, a differential gear device 24 and a pair of drive wheel axles 38. The connection/disconnection clutch K0, the electric motor MG, the starting clutch WSC and the automatic transmission 22 are housed within the casing 18, and are arranged in this order as viewed in a direction away from the engine 12 toward the drive wheels 14. The vehicle 10 further includes a hydraulic control circuit 60, an inverter 62, a battery 64 and an electronic control apparatus 40.

The engine 12 is a known internal combustion engine such as a gasoline engine or a diesel engine. The electric motor MG is, for example, a so-called motor generator, and is a three-phase synchronous electric motor. The electric motor MG is driven to be rotated by an electric power stored in the battery 64 transmitted via the inverter 62.

The connection/disconnection clutch K0 is an engagement device that can connect and disconnect the power transmission between the engine 12 and the electric motor MG, and the starting clutch WSC is an engagement device that can connect and disconnect the power transmission between the electric motor MG and the automatic transmission 22. Each of the connection/disconnection clutch K0 and the starting clutch WSC is, for example, a wet multi-plate hydraulic friction engagement device. A controlled state of each of the connection/disconnection clutch K0 and the starting clutch WSC is switched among an engaged state, a released state and a slip state by controlling a K0 hydraulic pressure PRk0 that is an engagement hydraulic pressure of the connection/disconnection clutch K0, or by controlling a WSC hydraulic pressure PRwsc that is an engagement hydraulic pressure of the starting clutch WSC, which are respectively regulated and supplied from the hydraulic control circuit 60. An electric motor drive shaft MGrt is a component that includes a rotor of the electric motor MG, and is connected to the connection/disconnection clutch K0 and the starting clutch WSC such that the electric motor drive shaft MGrt is not rotatable relative to the connection/disconnection clutch K0 and the starting clutch WSC. The engine 12 and the connection/disconnection clutch K0 are connected through a crankshaft 30. The connection/disconnection clutch K0m, the electric motor drive shaft MGrt and the starting clutch WSC are disposed on an axis CL, and are rotatable about the axis CL. The connection/disconnection clutch K0 and the starting clutch WSC correspond to “first clutch” and “second clutch” in the present invention, respectively.

The automatic transmission 22 is a known planetary gear type automatic transmission including one or more planetary gear devices (not shown) and a plurality of engagement devices CB. Each of the engagement devices CB is a hydraulic friction engagement device such as a multi-plate or single-plate clutch or brake that is to be pressed by a hydraulic actuator, or a band brake that is to be tightened by a hydraulic actuator. A controlled state of each of the engagement devices CB is switched between an engaged state and a released state, by controlling a regulated CB hydraulic pressure PRcb supplied from the hydraulic control circuit 60.

The automatic transmission 22 is a stepped transmission in which a selected one of a plurality of gear positions with different gear ratios γ (=input-shaft rotational speed Nin/output-shaft rotational speed Nout) is established by engaging at least one of the engagement devices CB. The automatic transmission 22 is switched among the gear positions in accordance with a driver's accelerator operation, a running speed V of the vehicle 10, for example, by the electronic control apparatus 40. In other words, the plurality of gear positions are selectively established. The input-shaft rotational speed Nin is a rotational speed of the input shaft 34 and is an input rotational speed of the automatic transmission 22. The input-shaft rotational speed Nin is also a rotational speed on an output member of the starting clutch WSC. The output-shaft rotational speed Nout is a rotational speed of the output shaft 36 and is an output rotational speed of the automatic transmission 22. When the automatic transmission 22 is in a neutral state, for example, by putting all of the engagement devices C and B into the released states, any one of the gear positions is established. When the automatic transmission 22 is in the neutral state, the automatic transmission 22 is placed in a power transmission disabled state in which the power cannot be transmitted through the automatic transmission 22.

The hydraulic control circuit 60 uses a hydraulic pressure of a working fluid OIL discharged from a fluid or oil pump (not shown) as a source pressure, and supplies the adjusted K0 hydraulic pressure PRk0, WSC hydraulic pressure PRwsc and CB hydraulic pressure PRcb, for example, based on controls executed by the electronic control apparatus 40.

The electronic control apparatus 40 includes a so-called microcomputer and executes various controls in the vehicle 10. The electronic control apparatus 40 corresponds to the “control apparatus” in the present invention. The electronic control apparatus 40 receives various signals (such as an engine rotational speed Ne [rpm] that is a rotational speed of the engine 12, an input-shaft rotational speed Nin [rpm], an output-shaft rotational speed Nout [rpm], an MG rotational speed Nmg [rpm] that is a rotational speed of the electric motor MG and a rotational speed of an input member of the starting clutch WSC, a charged value SOC of the battery 64 and an acceleration opening degree θacc [%]), which are based on values detected by various sensors (such as an engine rotational-speed sensor 70, an input-shaft rotational-speed sensor 72, an output-shaft rotational-speed sensor 74, an MG rotational-speed sensor 76, a battery sensor 78 and an acceleration opening-degree sensor 80). The charged value SOC is a ratio of an actual charged amount to a predetermined full charge capacity.

The electronic control apparatus 40 outputs various control signals (such as an engine control signal Se for controlling the engine 12, a CB-hydraulic-pressure control signal Scb for controlling the engagement devices CB of the automatic transmission 22, a K0 control signal Sk0 for controlling the K0 hydraulic pressure PRk0 of the connection/disconnection clutch K0, a WSC control signal Swsc for controlling the WSC hydraulic pressure PRwsc of the starting clutch WSC and an MG control signal Smg for controlling the electric motor MG via the inverter 62) to various devices (such as the engine 12, the hydraulic control circuit 60 and the inverter 62) provided in the vehicle 10.

The electronic control apparatus 40 calculates a requested drive amount for the vehicle 10 by the driver, for example, by applying the acceleration opening degree θacc and the running speed V to a requested drive amount map. The requested drive amount map represents a relationship for calculating the requested drive amount, wherein the relationship is determined in advance experimentally or by design and is stored. The requested drive amount is, for example, a requested drive torque Trdem [Nm] or a requested drive power Frdem [N] at the drive wheels 14. In other words, the requested drive torque Trdem is a requested drive power Prdem [W] at the current running speed V. The electronic control apparatus 40 outputs an engine control signal Se for controlling the engine 12 and an MG control signal Smg for controlling the electric motor MG, so as to realize the requested drive power Prdem, taking account of transmission loss, auxiliary load, the gear ratio of the automatic transmission 22 and other factors.

When the requested drive power Prdem can be covered by using only the output of the electric motor MG, the electronic control apparatus 40 sets a driving mode of the vehicle 10 to BEV (Battery Electric Vehicle) mode. The BEV mode is a driving mode in which the vehicle 10 is caused to run by the power of the electric motor MG with the connection/disconnection clutch K0 being in the released state and the starting clutch WSC being in the engaged state. On the other hand, when the requested drive power Prdem cannot be covered without using at least the output of the engine 12, the electronic control apparatus 40 sets the driving mode of the vehicle 10 to HEV (Hybrid Electric Vehicle) mode. The HEV mode is a driving mode in which the vehicle 10 is caused to run by the power of the engine 12 and optionally the power of the electric motor MG with the connection/disconnection clutch K0 being in the engaged state and the starting clutch WSC being in the engaged state.

In addition, in the HEV mode, the electronic control apparatus 40 places the starting clutch WSC in the released state when the vehicle 10 is being stopped, sets the starting clutch WSC in the slip state when the vehicle 10 starts running or is in a low-speed running state in which the running speed V is not higher than a predetermined speed value Vlo, and sets the starting clutch WSC in the engaged state when vehicle 10 is in a running state in which the running speed V is higher than the predetermined speed value Vlo. The predetermined speed value Vlo is a threshold value that is set in advance by design or experimentation based on conditions required to prevent engine stall and suppress vibration and shock of vehicle 10.

Further, the electronic control apparatus 40 executes an evacuation driving LD when any of the plurality of gear positions becomes unavailable in the automatic transmission 22, namely, in event of a gear-position limited state GPL in which the automatic transmission 22 cannot be placed in the gear positions except in at least one available gear position GP. The gear-position limited state GPL could occur, for example, when at least one of solenoid valves of the engagement devices CB fails in the hydraulic control circuit 60.

When the gear position that cannot be used in the automatic transmission 22 is a low-speed gear position used when the vehicle 10 starts running, the available gear positions GP become a high-speed gear position. The low-speed gear position used when the vehicle 10 starts running is, for example, a first-speed gear position, i.e., a gear position whose gear ration is the highest. When considering the evacuation driving in the high-speed gear position, especially, so as to cause the vehicle 10 to start running from stop or to run at a low speed, if the automatic transmission 22 is placed in a high-speed gear position other than the first-speed gear position, the torque that must be inputted to the automatic transmission 22 to obtain the requested drive torque Trdem, i.e., the transmission torque of the starting clutch WSC, is higher as compared to the first-speed gear position. Further, since the input-shaft rotational speed Nin is lower than in first-speed gear position, the amount and duration of slip of the starting clutch WSC, i.e., the slip-state region, is increased to prevent the engine stalling. Such an increase of the torque transmitted by the starting clutch WSC or of the slip-state region increases heat generated in the starting clutch WSC, and there is a risk that overheating could cause component damage or poor running start or insufficient driving force due to load factor restrictions.

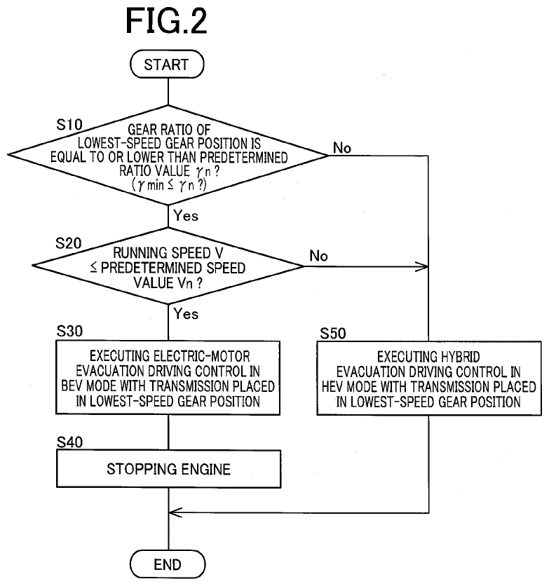

Therefore, the electronic control apparatus 40 executes a control shown in a flowchart of FIG. 2 so as to prevent component damage and poor running start due to overheating of the starting clutch WSC while performing the evacuation driving LD. FIG. 2 is the flowchart showing main parts of control operations of the electronic control apparatus 40, namely, a control routine executed for performing the evacuation driving LD when the automatic transmission 22 is in the gear-position limited state GPL.

As shown in FIG. 2, the control routine is initiated with step S10 that is implemented to determine whether the gear ratio γmin of the lowest-speed gear position GPmin, which has the highest gear ratio γ among the available gear positions GP (hereinafter referred to as the lowest-speed-gear-position gear ratio) is equal to or lower than a predetermined ratio value γn. This determination corresponds to determining whether a lowest-speed gear position GPmin, i.e., a lowest running-speed gear position among the available gear positions GP, is the same as or higher than a predetermined gear position (e.g., first or second gear position) GPn, which has a predetermined ratio value γn.

When an affirmative determination is made at step S10, step S20 is implemented to determine whether the running speed V is equal to or lower than the predetermined speed value Vn. When an affirmative determination is made at step S20, step S30 is implemented to executes an electric-motor evacuation driving control BEVLD in the BEV mode, with the automatic transmission 22 being placed in the lowest-speed gear position GPmin. This prevents component damage and poor running start due to heat generated in the starting clutch WSC, while performing the evacuation driving LD.

Next, at step S40, the engine 12 is stopped, and one cycle of execution of the control routine is terminated. By stopping the engine 12, unnecessary operation of the engine 12 is suppressed.

The predetermined ratio value γn and the predetermined speed value Vn are threshold values that are determined in advance by design or experimentation in order to prevent component damage and poor running start due to overheating of the starting clutch WSC.

Preferably, the lower the lowest-speed-gear-position gear ratio γmin, the higher the predetermined speed value Vn is set. For example, the predetermined speed value Vn is set by using a map in which the predetermined speed value Vn is increased as the lowest-speed-gear-position gear ratio γmin is reduced. As a result, the higher the lowest-speed gear position GPmin becomes, the higher the predetermined speed value Vn is set, and the range in which the electric-motor evacuation driving control BEVLD is executed expands toward a high speed side of the running speed V, enabling the electric-motor evacuation driving control BEVLD to be appropriately executed to prevent component damage and poor running start caused by heat generation in the starting clutch WSC.

When a negative determination is made at step S10 or S20, the control flow goes to step S50 at which a hybrid evacuation driving control HEVLD is executed in the HEV mode by placing the automatic transmission 22 in the lowest-speed gear position GPmin, and then one cycle of execution of the control routine is terminated. As a result, in a running state in which the impact of heat generated in the starting clutch WSC is small, the hybrid evacuation driving control HEVLD is executed in the HEV mode with use of the power of engine 12. This makes it possible to increase a distance by which the evacuation driving LD can be performed, as compared to executing only the electric-motor evacuation driving control BEVLD that can be executed within range of the charge capacity of the battery 64.

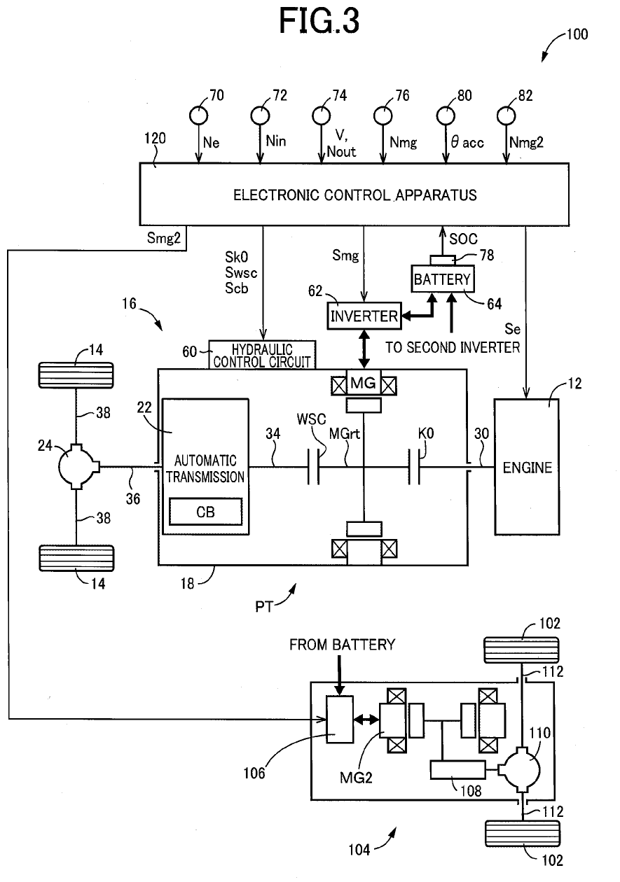

FIG. 3 is a view schematically showing a construction of a four-wheel drive (4WD) vehicle 100 of a comparative example, for explaining the evacuation driving LD performed in this vehicle 100 of the comparative example when the automatic transmission 22 is in the gear-position limited state. In the four-wheel drive vehicle 100, a second drive apparatus 104 configured to drive auxiliary drive wheels 102 is added to the above-described two-wheel drive (2WD) vehicle 10 (shown in FIG. 1). It is noted that components that are common to those in the vehicle 10 are given the same reference signs and will not be described.

The second drive apparatus 104 includes a second electric motor MG2 that is a power source, a second inverter 106, a speed reducer 108 and a second differential gear device 110. Like the electric motor MG, the second electric motor MG2 is a so-called motor generator, and is a three-phase synchronous electric motor. Like the inverter 62, the second inverter 106 is connected to the battery 64 in a manner that allows it to exchange the electric power with the battery 64. The second electric motor MG2 is driven to be rotated by the electric power stored in the battery 64 and exchanged via the second inverter 106. The power of the second electric motor MG2 is transmitted to the auxiliary drive wheels 102 via the speed reducer 108, the second differential gear device 110 and a pair of auxiliary drive wheel axles 112.

An electronic control apparatus 120, which executes various controls in the vehicle 100, has an input function (input of a rotational speed Nmg2 [rpm] of the second electric motor MG2 based on a value detected by an MG2 rotational-speed sensor 82) and an output function (output of an MG2 control signal Smg2 for controlling the second electric motor MG2 via the second inverter 106), which are added to the electronic control apparatus 40 of the vehicle 10. The electronic control apparatus 120 distributes the requested drive torque Trdem [Nm] of the vehicle 100 to the drive wheels 14 and the auxiliary drive wheels 102 based on the running state of the vehicle 100, for example, so as to drive the vehicle 100.

In event of the gear-position limited state GPL, the evacuation driving LD is performed also in the vehicle 100. For example, when the running speed V of the vehicle 100 is equal to or higher than a predetermined speed value Vn2, a first evacuation driving LD1 is performed whereby the automatic transmission 22 is placed in the lowest-speed gear position GPmin and the vehicle 100 is driven in the HEV mode. When the running speed V of vehicle 100 is lower than the predetermined speed value Vn2, a second evacuation driving LD2 is performed whereby the starting clutch WSC is placed in the released state or the automatic transmission 22 is placed in the neutral state so as to cut off power transmission to the drive wheels 14, and the auxiliary drive wheels 102 are driven by the power of the second electric motor MG2. Similar to the above-described predetermined speed value Vn, the predetermined speed value Vn2 is used to prevent component damage due to overheating of the starting clutch WSC and poor running start. The predetermined speed value Vn2 is a threshold value that is determined in advance by design or experimentation.

In the above-described vehicle 10, the hybrid evacuation driving control HEVLD is executed as an evacuation driving control equivalent to the first evacuation driving LD1 in the vehicle 100, and the electric-motor evacuation driving control BEVLD is executed as an evacuation driving control equivalent to the second evacuation driving LD2 in the vehicle 100. In other words, the evacuation driving LD, which prevents component damage and poor running starts due to overheating of the second clutch, is performed in vehicle 10 that is a two-wheel drive (2WD) vehicle, just as in a four-wheel drive (4WD) vehicle.

As described above, according to the electronic control apparatus 40 of the present embodiment, when the running speed V of the vehicle 10 is not higher than the predetermined speed value Vn in event of the gear-position limited state GPL in which the automatic transmission 22 cannot be placed in the gear positions except in the at least one available gear position GP, such that the lowest-speed gear-position gear ratio γmin of the lowest-speed gear position GPmin of the at least one available gear position GP, which is higher than the gear ratio γ of any other gear position of the at least one available gear position GP, is not higher than the predetermined ratio value γn, the electronic control apparatus 40 is configured to execute the electric-motor evacuation driving control BEVLD for driving the vehicle 10 with the power of the electric motor MG, by placing the automatic transmission 22 in the lowest-speed gear position GPmin, placing the K0: connection/disconnection clutch in the released state and placing the starting clutch WSC in the engaged state. As a result, in the two-wheel drive (2WD) vehicle, even when the at least one available gear position GP is limited to a high-speed gear position with a low gear ratio, due to an abnormality in the automatic transmission 22, the evacuation driving LD is performed while preventing component damage and poor running starts due to overheating of the starting clutch WSC.

Further, according to the electronic control apparatus 40 of the present embodiment, the engine 12 is stopped while the electric-motor evacuation driving control BEVLD is being executed. This prevents the engine 12 from being driven unnecessarily.

Further, according to the electronic control apparatus 40 of the present embodiment, the lower the lowest-speed-gear-position gear ratio γmin, the higher the predetermined speed value Vn is set. As a result, the higher the lowest-speed gear position GPmin, the higher the predetermined speed value Vn is set, and the range in which the electric-motor evacuation driving control BEVLD is performed expands toward a high vehicle speed side of the running speed V, so that the electric-motor evacuation driving control BEVLD is appropriately performed to prevent component damage and poor running starts caused by heat generation in the starting clutch WSC.

According to the electronic control apparatus 40 of the present embodiment, in the gear-position limited state GPL, when the lowest-speed-gear-position gear ratio γmin is higher than the predetermined ratio value γn or the running speed V is higher than the predetermined speed value Vn, the automatic transmission 22 is placed in the lowest-speed gear position GPmin and the hybrid evacuation driving control HEVLD is performed to drive the vehicle 10 in the HEV mode. As a result, in a running state in which the impact of heat generation in the starting clutch WSC is small, the hybrid evacuation driving control HEVLD is executed in the HEV mode in which the power of the engine 12 can be used. This extends a distance by which the vehicle 10 can be driven in the evacuation driving LD as compared to where only the electric-motor evacuation driving control BEVLD is executed within a range of the charge amount of the battery 64.

Although the embodiment of the present invention has been described in detail above with reference to the drawings, the present invention can also be applied to other embodiments.

For example, in the above-described embodiment, the planetary-gear type automatic transmission is used as the automatic transmission 22, but this is not limiting. For example, the automatic transmission 22 may be a synchronous mesh type parallel two-shaft automatic transmission including a known DCT (Dual Clutch Transmission).

It should be noted that the above is merely one embodiment, and the present invention can be embodied in various forms with various modifications and improvements based on the knowledge of those skilled in the art without departing from the spirit of the present invention.

### NOMENCLATURE OF ELEMENTS

10: vehicle (two-wheel drive vehicle)
12: engine
14: drive wheels
22: automatic transmission
40: electronic control apparatus
BEVLD: electric-motor evacuation driving control
GP: available gear positions
GPL: gear-position limited state
GPmin: lowest-speed gear position
HEVLD: hybrid evacuation driving control
K0: connection/disconnection clutch (first clutch)
MG: electric motor
PT: power transmission path
V: running speed
Vn: predetermined speed value
WSC: starting clutch (second clutch)
γ: gear ratio
γmin: lowest-speed-gear-position gear ratio (gear ratio of lowest-speed gear position)
γn: predetermined ratio value

What is claimed is:

1. A control apparatus for a two-wheel drive vehicle that includes an engine, drive wheels, a first clutch, an electric motor, a second clutch and an automatic transmission that is to be placed in a plurality of gear positions, such that the first clutch, the electric motor, the second clutch and the automatic transmission are disposed in a power transmission path between the engine and the drive wheels and are arranged in this order as viewed in a direction away from the engine toward the drive wheels,
wherein, when a running speed of the vehicle is not higher than a predetermined speed value in event of a gear-position limited state in which the automatic transmission cannot be placed in the gear positions except in at least one available gear position, such that a gear ratio of a lowest-speed gear position of the at least one available gear position, which is higher than a gear ratio of any other gear position of the at least one available gear position, is not higher than a predetermined ratio value, the control apparatus is configured to execute an electric-motor evacuation driving control for driving the vehicle with a power of the electric motor, by placing the automatic transmission in the lowest-speed gear position, placing the first clutch in a released state and placing the second clutch in an engaged state.

2. The control apparatus according to claim 1,
wherein the control apparatus is configured to stop the engine during execution of the electric-motor evacuation driving control.

3. The control apparatus according to claim 1,
wherein the control apparatus is configured to set the predetermined speed value, such that the lower the gear ratio of the lowest-speed gear position, the higher the predetermined speed value.

4. The control apparatus according to claim 1,
wherein, in event of the gear-position limited state, when the running speed of the vehicle is higher than the predetermined speed value or when the gear ratio of the lowest-speed gear position is higher than the predetermined ratio value, the control apparatus is configured to execute a hybrid evacuation driving control for driving the vehicle with at least a power of the engine, by placing the automatic transmission in the lowest-speed gear position, placing the first clutch in an engaged state and placing the second clutch in the engaged state or a slip state.
